(19) United States
(12) Patent Application Publication
(10) Pub. No.: US 2025/0174449 A1
(43) Pub. Date: May 29, 2025

(54) MSn MASS SPECTROMETRY SYSTEM AND RELATED METHODS

(71) Applicant: Thermo Fisher Scientific (Bremen) GmbH, Bremen (DE)

(72) Inventors: Hamish Stewart, Bremen (DE); Alexander Makarov, Bremen (DE)

(21) Appl. No.: 18/959,361

(22) Filed: Nov. 25, 2024

(30) Foreign Application Priority Data
Nov. 28, 2023 (GB) 2318148.0

(51) Int. Cl. H01J 49/42; H01J 49/00; H01J 49/40

(52) U.S. Cl. CPC H01J 49/4215; H01J 49/0031; H01J 49/0045; H01J 49/406

(57) ABSTRACT

A mass spectrometry system is configured to perform MSⁿ mass spectrometry, where n is greater than or equal to 3. The mass spectrometry system comprises: a first mass filter having a first maximum resolution; a first fragmentation device downstream of the first mass filter and configured to fragment ions received from the first mass filter; a second mass filter downstream of the first fragmentation device, the second mass filter having a second maximum resolution that is lower than the first maximum resolution; a second fragmentation device downstream of the second mass filter; and a first mass analyser downstream of the second fragmentation device.

### CROSS-REFERENCE TO RELATED APPLICATION

This application claims priority from UK patent application no. GB2318148.0, filed Nov. 28, 2023. The entire disclosure of GB2318148.0 is incorporated herein by reference.

### FIELD

The present disclosure concerns mass spectrometry systems configured to perform MSⁿ mass spectrometry, where n is greater than or equal to 3, and related methods.

### BACKGROUND

In tandem mass spectrometry, analyte ions are typically isolated, fragmented and then the fragments are mass analysed to return structural and sometimes quantitative information. These are termed MS/MS, MS2, or MS² scans. Survey scans, termed MS, Full-MS, MS1, or MS¹ scans, of the unfragmented analyte ions are often also performed to produce high quality information on these analytes. In data dependent acquisition (DDA), MS¹ scans generate target lists of precursors for fragmentation.

A typical data dependent analysis (DDA) MS workflow involves repeatedly performing (e.g., during a chromatographic separation run) the steps of (i) obtaining an MS¹ spectrum across an m/z range of interest; (ii) identifying plural precursor ions of interest in the MS¹ spectrum; and (iii) obtaining an MS² spectrum in respect of each the identified precursor ions of interest. Step (iii) comprises, for each of the identified precursor ions: isolating the precursor ion, fragmenting the isolated precursor ions and mass analysing the fragment ions. In data independent analysis (DIA), the MS² isolation window m/zs are not determined from an MS¹ spectrum, but instead a narrow m/z isolation window is stepped across the entire m/z range of interest.

In all but highly specialised mass spectrometers, the isolation is performed at relatively low resolution via a quadrupole mass filter or an ion trap, and also in some cases via ion mobility separators. Whilst generally successful, excessive filtering of ions can be wasteful of signal, also such isolation is not always very specific and analyte species may interfere with one another, even as fragments. A particularly important example of this phenomenon is with quantitation via tandem mass tags (Thompson et al, Anal. Chem., 2003, 75, 1895-1904), known as TMT (Pierce) or iTRAQ (Sciex-Isobaric Tagging for Relative Quantitation). Here, fragmentation of tagged precursor ions causes release of the tags, the relative intensities of which are measured to provide quantitative information. However, the same tags are released from different analyte species so that without highly specific isolation, interfering precursors can produce interferences among the TMT reporter ions. There are also cases where a single fragmentation step produces only limited information, for example when phosphopeptides react to collision energy by loss of the phosphate group, often providing little further information.

For such cases, an additional isolation and fragmentation step prior to analysis, MS³, may prove beneficial. For TMT quantitation, for example, the most prominent fragment may be struck again and reporter ions unique to a single parent peptide detected (Ting et al, Nat. Meth., 2011, 8, 937-940), whilst real time identification data may be additionally used to ensure that a target is suitable for MS³ analysis so as not to waste limited time and signal (Furtwängler et al, Mol. Cell. Prot., 2022, 21, 100219).

A problem with MS³ analysis is that it is not directly compatible with most common tandem mass spectrometers, triple quadrupoles and instruments combining a quadrupole with a high-resolution analyser such as an orbital trapping analyser (e.g., an Orbitrap™ analyser) or a Time-of-Flight (ToF) analyser. A single quadrupole means a single isolation step is performed as ions move across the instrument. With high performance quadrupole mass filters being relatively expensive as well as requiring regular maintenance, adding an extra mass filter and fragmentation device adds substantial complexity, size and other issues to an instrument.

U.S. Pat. No. 7,145,133-B2 recognises that fragment ions can be accumulated and passed backwards through a quadrupole, allowing an additional isolation/fragmentation step on identical hardware. U.S. Pat. No. 7,145,133-B2 also proposes the use of an additional trapping device to accumulate ions from the source whilst the quadrupole and surrounding devices are blocked by the back-and-forth MS³⁽⁺⁾ process. A flowchart of this method is shown in FIG. 1. Whilst FIG. 1 proposes a way to carry out MS³ with a single quadrupole and without strictly requiring additional hardware, most common MS³ analysis is carried out within ion traps, such as currently found on the Orbitrap Fusion™ series of instruments.

A hybrid mass spectrometer of U.S. Pat. No. 10,699,888-B2 is shown in FIG. 2, which incorporates a quadrupole mass filter, an orbital trapping mass analyser, and a multi-reflection time-of-flight (MR-ToF) analyser as described in U.S. Pat. No. 9,136,101-B2. A full description of FIG. 2 is omitted for brevity but can be found in U.S. Pat. No. 9,136,101-B2. Ions generated by an electrospray source 20 traverse the vacuum interface, incorporating transfer tube 25, ion funnel 30, and a pair of ion guides (Quadrupole Pre-Filter 40 and Bent Flatapole 50), before being mass selected by a quadrupole 70 and accumulated/fragmented in a collision cell (named Ion-Routing Multipole/IRM 120), before being passed back to the C-Trap 100 and pulse-ejected into the orbital trapping mass analyser 110 where the ions are analysed. Alternatively, the analyte ions collected in the IRM 120, are passed through a multipole guide 130 to the extraction trap 140, where they may also be fragmented prior to pulse extraction into the MR-ToF analyser 150 and mass measurement. The quadrupole pre-filter 40 is an interesting example of a relatively low-cost, low performance quadrupole used as a rough mass filter to protect the expensive main mass filter 70 from contamination and space charge effects, and was described in U.S. RE45553E1.

The bent flatapole 50 in FIG. 2 is a gas filled multipole ion guide with a superimposed DC gradient generated by additional DC only electrodes. This is constructed in the manner described in U.S. Pat. No. 9,536,722-B2 and reproduced in FIG. 3. However, there are many ways to achieve a similar mechanism by providing DC structures that may be built independently of the RF trapping electrodes (though segmentation of RF electrodes is another method). FIG. 3 specifically shows a prior art construction of a quadrupole ion guide with a superimposed axial field generated by auxiliary electrodes.

A relatively recent innovation has been the introduction of devices that accumulate ions and release them downstream in approximate order (ascending or descending) of mass-to-charge ratio (m/z) (or in order of some other quantity correlated with m/z, such as ion mobility). These may be described as “ion scheduling devices”, and they convert a continuous mixed m/z beam into packets of limited m/z or mobility range. Ion scheduling devices may be coupled to a quadrupole, as first considered in GB-2,442,638-A, so that the quadrupole makes only a fine filtration step and relatively few ions are lost to the quadrupole. This reduces ion losses substantially, in some circumstances enhancing sensitivity by an order of magnitude, with perhaps another order of magnitude improvement being attainable.

An example of ion scheduling devices is the trapped in mass spectrometry TIMS device, and its associated PASEF method (Meier et al. J. Prot. Res. 2015, 12, 5378-5387, US-2017/0122906-A1 and U.S. Pat. No. 10,794,861-B2). Many other methods are reported, including m/z separation via balance of opposing RF and DC (U.S. Pat. No. 6,914,241-B2), and accumulation into multiple traps; either orthogonally across an RF pseudopotential (U.S. Pat. No. 10,199,208-B2) or via ion mobility (US-2017/0076928-A1). Ion separation over very long printed circuit board-based (PCB-based) ion guides such as SLIM (Structures for Lossless Ion Mobility) are also promising as such a device, and may operate at sufficient mobility resolution that the quadrupole becomes redundant (Hamid et al, Anal. Chem. 2015, 87, 11301-11308).

While the above-noted systems perform adequately in some respects, there remains a need for improved mass spectrometry systems. For example, there is a need for faster and/or more efficient mass spectrometry systems, particularly for MS³ (or MSⁿ where n is greater than 3) analysis.

### SUMMARY

Against this background, the present disclosure provides a mass spectrometry system according to claim 1 and a method according to claim 21.

The present disclosure provides mass spectrometry systems that can perform fast and efficient MS³ (or higher) analysis on modified versions of existing hardware (e.g., a modified Thermo Scientific™ Orbitrap™ Astral™ mass spectrometer).

In some embodiments, the existing RF-only ion guide that separates the orbital trapping mass analyser and the MR-ToF analyser in the instrument of FIG. 2 is replaced with a relatively low performance mass filter (e.g., a wide window quadrupole). Then, MS² isolation and fragmentation can be performed by the main quadrupole mass filter and collision cell (as normal), while MS³ isolation and fragmentation can be performed by the low performance mass filter and a high-pressure region of the ToF extraction trap can be used for MS³ fragmentation and analysis. As MS³ isolation requires less resolution than MS² isolation, a lower performance quadrupole mass filter can be used without sacrificing performance, thereby facilitating a system that can be manufactured efficiently at low-cost and without requiring extensive complex modifications.

Ion scheduling devices can be introduced to reduce ion losses in MS³ filtration, and various types of ion scheduling devices (e.g., ion mobility separators, SLIM devices, trap accumulators, opposing T-Wave/DC separators, and/or RF carpet type devices) are compatible with the methods described herein.

Some embodiments provide TMT measurements that may serve to increase peptide identifications (IDs) and reduce interference in quantitation.

In some embodiments, ions are repeatedly isolated and fragmented by the same mass filter and fragmentation device, by passing fragment ions back through the quadrupole and accumulating them in an accumulation region upstream of the quadrupole (before they are sent again through and isolated by the quadrupole; see FIG. 1, for instance). Two separate accumulation regions can be provided upstream of the quadrupole mass filter, so that both ions from the ion source and the fragment ions passed back from the fragmentation device can be simultaneously accumulated upstream of the quadrupole (in order to reduce losses; see FIG. 6, for example).

A general problem addressed by embodiments of the present disclosure is how to accomplish MS³ analysis on limited hardware, whilst operating very quickly (e.g., at repetition rates of >50 Hz, preferably >100 Hz, to avoid severely bottlenecking an MR-ToF analyser), and with high sensitivity and resilience to space charge effects. In the method shown in FIG. 1, the MS³ step adds ˜5-10 ms to the analysis. Some embodiments of the disclosure add MS³ capability to the hybrid instrument shown in FIG. 2, in an advantageous manner.

As mentioned, MS³ analysis is generally performed on instruments incorporating quadrupole ion traps. These are normally unsuitable as primary isolation devices due to their limited ion capacity, and are relatively costly to pair with an analytical quadrupole, particularly for applications that also require a high-performance mass analyser (see U.S. Pat. No. 6,833,544-B1), such as found in the Orbitrap Fusion™ instruments. Hence, some embodiments may also adapt an existing region such as a collision cell with ion trap functionality, via addition of additional AC for isolation or excitation.

The above-noted advantages and other advantages will become apparent from the following disclosure.

### BRIEF DESCRIPTION OF THE DRAWINGS

FIG. 1 shows a prior art method of performing pass-back MS³ analysis.

FIG. 2 shows a prior art mass spectrometry system.

FIG. 3 shows a prior art bent flatapole.

FIG. 4 shows a mass spectrometry system incorporating a low-performance mass filter, in a first embodiment.

FIG. 5 shows a DIA scheme, for use in embodiments of the present disclosure.

FIG. 6 shows how distinct trapping regions can be formed, for use in embodiments of the present disclosure.

FIG. 7 shows a mass spectrometry system incorporating ion scheduling devices, in a second embodiment.

FIG. 8 shows a mass spectrometry system incorporating ion scheduling devices, in a third embodiment.

FIG. 9 shows a mass spectrometry system incorporating ion scheduling devices, in a fourth embodiment.

FIG. 10 shows a method of performing mass spectrometry, in a fifth embodiment.

FIG. 11 shows a method of performing mass spectrometry, in a sixth embodiment.

FIGS. 12A-12C show electrode arrangements for use in the ion scheduling devices of embodiments of the disclosure.

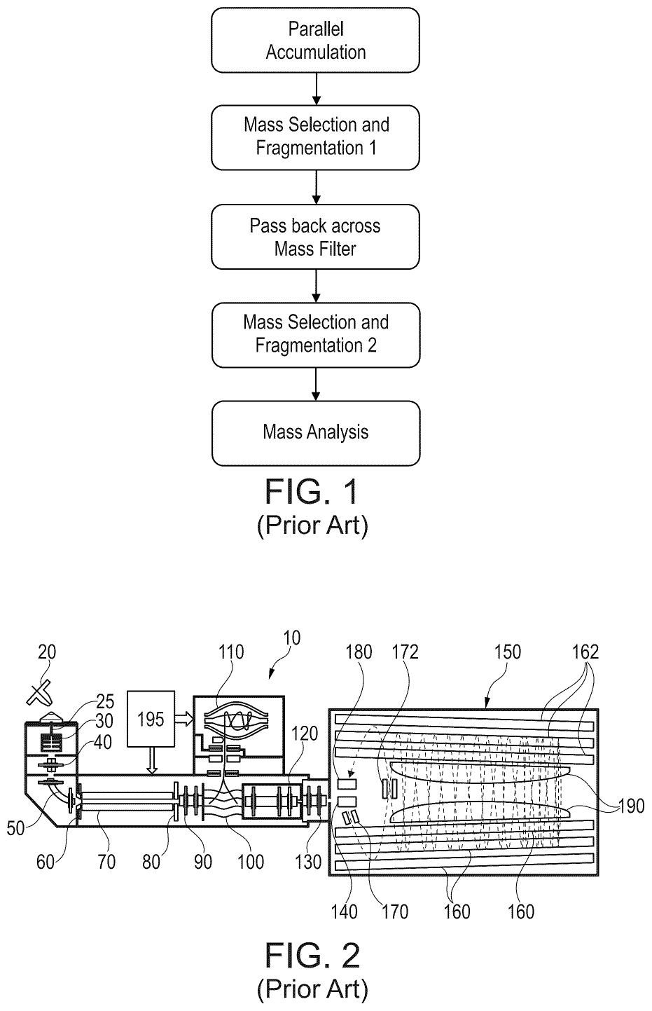

### DETAILED DESCRIPTION

The disclosure provides systems and methods to provide efficient MS³ analysis in various mass spectrometry systems. Particular advantages arise in hybrid orbital trapping mass analyser/MR-ToF mass spectrometers, but the disclosure is not limited to such analysers and other mass analysers can benefit from the architectures described herein.

Some embodiments of the disclosure provide hardware, e.g. via splitting of a DC gradient in an upstream accumulation device (e.g., a bent flatapole), to generate two separate accumulation regions, both for pre-accumulation of ions from an ion source and for storage of returned fragments from an MS² step; such embodiments can facilitate further MS³ analysis quickly and efficiently.

In some embodiments, an additional low performance quadrupole mass filter is provided and MS³ analysis is performed using this additional filter, rather than using a pass-back method, replacing the existing ion guide that separates the two analysers, as shown in FIG. 4. As MS² spectra are normally much more sparse than full-MS, the requirement for good separation is much lower, i.e., a resolution of 1000 is not required and thus a second filter may be produced at a small fraction of the accuracy and cost. The use of a very fast (i.e., high repetition rate) ToF analyser in tandem with an orbital trapping mass analyser also makes data-independent MS³ methods readily achievable, where a vast number of MS³ spectra may be acquired by the ToF analyser whilst the orbital trapping mass analyser can acquire MS¹ and optionally also MS² spectra.

Moreover, some embodiments introduce an ion scheduling device both in the conventional location prior to the quadrupole, and also incorporated into a first collision region/IRM to eliminate or at least reduce the high losses associated with MS³ analysis.

FIG. 4 shows suitable hardware for implementing embodiments of the present disclosure. Specifically, FIG. 4 shows a schematic arrangement of a mass spectrometry system 10 (which is also described herein as a mass spectrometer) suitable for carrying out methods in accordance with embodiments of the present disclosure. FIG. 4 is similar to FIG. 2, with some differences, as will be explained below.

In FIG. 4, a sample of ions is supplied from a sample (which may be provided, for example, from an autosampler or other sample source). The sample of ions can be provided by ionising molecules using, for example, an electrospray ionization source (ESI source) 20, which can be at atmospheric pressure. Gas chromatography and/or liquid chromatography could be performed upstream of the mass spectrometry system 10.

The sample of ions then enters a vacuum chamber of the mass spectrometer 10 and the ions are directed by a capillary 25 into an ion funnel 30, where an optional calibrant source 35 is provided. The ions are funnelled into a quadrupole pre-filter 40, which injects the ions into a bent flatapole ion guide 50 with an axial field. The bent flatapole 50 guides (charged) ions along a curved path through it while unwanted neutral molecules, such as entrained solvent molecules, are not guided along the curved path and are lost.

Downstream, a first mass filter 70 is provided, in the form of a quadrupole mass filter 70. In this embodiment, the mass filter 70 is a high performance (e.g., high resolution) quadrupole mass filter. The quadrupole mass filter 70 may be (but is not necessarily) segmented and serves as a band pass filter, allowing passage of a selected mass number or limited m/z range while excluding ions of other mass to charge ratios (m/z). The mass filter can also be operated in an RF-only mode in which it is essentially not mass selective, i.e., it transmits substantially all m/z ions. For example, the quadrupole mass filter 70 may be controlled by a controller (not shown) to select a range of mass to charge ratios to pass of the precursor ions which are allowed to pass, while the other ions in the precursor ion stream are filtered.

Although a quadrupole mass filter is shown in FIG. 4, the skilled person will appreciate that other types of mass selection devices may also be suitable for selecting ions within the m/z range of interest. For example, an ion separator as described in US-2015/287585-A, an ion trap as described in WO-2013/076307-A, an ion mobility separator as described in US-2012/256083-A, an ion gate mass selection device as described in WO-2012/175517-A, or a charged particle trap as described in U.S. Pat. No. 7,999,223, may be used, the contents of which are hereby incorporated by reference in their entirety. The skilled person will appreciate that other methods of selecting precursor ions according to ion mobility, differential mobility and/or transverse modulation may also be suitable.

The ions then pass through a quadrupole exit lens/split lens arrangement, which is provided with a charge detector 80. The mass filtered ions are guided from the quadrupole mass filter 70 into a curved linear ion trap (C-trap) 100. The C-trap 100 has longitudinally extending, curved electrodes, which are supplied with RF voltages, and end caps to which DC voltages are supplied. The result is a potential well that extends along the curved longitudinal axis of the C-trap 100. In a first mode of operation, the DC end cap voltages are set on the C-trap so that arriving ions are captured in the potential well of the C-trap 100, where they are cooled. The injection time (IT) of the ions into the C-trap (together with the abundance of ions) determines the number of ions (ion population) that is stored in and subsequently ejected from the C-trap.

Cooled ions reside in a cloud towards the bottom of the potential well and can be ejected orthogonally from the C-trap towards a second mass analyser 110 of the mass spectrometry system (with the ToF mass analyser 150, which is described in further detail below, being denoted herein as a first mass analyser). As shown in FIG. 4, the second mass analyser is an orbital trapping mass analyser 110, for example the Orbitrap® mass analyser sold by Thermo Fisher Scientific, Inc. The orbital trapping mass analyser 110 has an off-centre injection aperture and the ions are injected into the orbital trapping mass analyser 110 as coherent packets, through the off-centre injection aperture. Ions are then trapped within the orbital trapping mass analyser by a hyperlogarithmic electric field, and undergo back and forth motion in a longitudinal direction while orbiting around the inner electrode.

The axial (z) component of the movement of the ion packets in the orbital trapping mass analyser is (more or less) defined as simple harmonic motion, with the angular frequency in the z direction being related to the square root of the mass to charge ratio of a given ion species. Thus, over time, ions separate in accordance with their mass-to-charge ratio.

Ions in the orbital trapping mass analyser are detected by use of an image current detector (not shown) which produces a “transient” in the time domain containing information on all of the ion species as they pass the image current detector. The transient is then subjected to a Fast Fourier Transform (FFT) resulting in a series of peaks in the frequency domain. From these peaks, a mass spectrum, representing abundance/ion intensity versus m/z, can be produced.

In the configuration described above, the sample ions (or, a m/z range segment of the sample ions within a m/z range of interest, selected by the quadrupole mass filter) can be analysed by the orbital trapping mass analyser without fragmentation. The resulting mass spectrum is denoted MS¹. However, in some embodiments of the present disclosure, ions could be passed into the orbital trapping mass analyser after having been fragmented one or a plurality of times and could therefore be MSⁿ ions, the analysis of which produces an MSⁿ spectrum.

Although an orbital trapping mass analyser 110 is shown in FIG. 4, other mass analysers, such as ToF mass analysers or other Fourier Transform mass analysers, may be employed instead. For example, a Fourier Transform Ion Cyclotron Resonance (FTICR) mass analyser may be utilized as a mass analyser for MS¹ scans. Mass analysers, such as the orbital trapping mass analyser and Ion Cyclotron Resonance mass analyser, may also be used in some embodiments of the present disclosure, even where other types of signal processing than Fourier transformation are used to obtain mass spectral information from the transient signal (see for example WO-2013/171313, Thermo Fisher Scientific). Moreover, while some embodiments perform MS¹ and/or MS² analysis, the orbital trapping mass analyser 110 could be omitted entirely if only MS³ data were desired.

In a second mode of operation of the C-trap 100, ions passing through the quadrupole 70 exit into the C-trap 100 and may continue their path through the C-trap and into the first fragmentation device 120 (which is shown as an “Ion Routing Multipole” collision cell, which is also described herein as a fragmentation chamber). Hence, the C-trap effectively operates as an ion guide in the second mode of operation. Alternatively, cooled ions in the C-trap 100 may be ejected from the C-trap in an axial direction into the fragmentation chamber 120. The fragmentation chamber 120 is, in the mass spectrometer 10 of FIG. 4, a higher energy collisional dissociation (HCD) device to which a collision gas is supplied. Precursor ions arriving into the fragmentation chamber 120 with sufficient kinetic energy collide with collision gas molecules resulting in fragmentation of the precursor ions into fragment ions.

Although an HCD fragmentation chamber 120 is shown in FIG. 4, other fragmentation devices may be employed instead, employing such methods as collision induced dissociation (CID), electron capture dissociation (ECD), electron transfer dissociation (ETD), photodissociation, and so forth.

Fragmented ions may be ejected from the fragmentation chamber 120 at the opposing axial end to the C-trap 100 (i.e., the downstream end). The ejected fragmented ions pass into a (relatively wide window) second mass filter 135, which in this embodiment is a quadrupole mass filter. The second mass filter 135 guides the fragmented ions from the fragmentation chamber 120 into an extraction trap (second ion trap) 140. The extraction trap 140 is a radio frequency voltage-controlled trap containing a buffer gas. For example, a suitable buffer gas is nitrogen at a pressure in the range 5×10⁻⁴ mBar to 1×10⁻² mBar. Ions arriving into the extraction trap 140 with sufficient kinetic energy may collide with buffer gas molecules resulting in fragmentation of the ions into fragment ions. Therefore, the extraction trap 140 may serve as a fragmentation device.

The extraction trap has the ability to quickly switch off the applied RF voltage and apply a DC voltage to extract the trapped ions. A suitable flat plate extraction trap, also referred to as a rectilinear ion trap, is further described in U.S. Pat. No. 9,548,195 (B2). Alternatively, a C-trap may also be suitable for use as a second ion trap.

The extraction trap 140 is provided to form an ion packet of fragmented ions, prior to injection into the first mass analyser 150, which is shown in FIG. 4 as a MR-ToF mass analyser. The extraction trap 140 accumulates fragmented ions prior to injection of the fragmented ions into the ToF mass analyser 150. If an appropriate gas pressure is provided within a region of the extraction trap 140, then this region of the extraction trap 140 can act as a second fragmentation device that can perform a second fragmentation step on received ions (and thereby facilitate MSⁿ analysis, where n can be 3 or more).

Although an extraction trap (ion trap) is shown in the embodiment of FIG. 4, the skilled person will appreciate that other methods of forming an ion packet of fragmented ions will be equally suitable for the present disclosure. For example, relatively slow transfer of ions through a multipole can be used to affect bunching of ions, which can subsequently be ejected as a single packet to the TOF mass analyser. Alternatively, orthogonal displacement of ions may be used to form a packet. Further details of these alternatives are found in US-2003/0001088 A1 which describes a travelling wave ion bunching method, the contents of which are herein incorporated by reference.

In FIG. 4, the first mass analyser 150 shown is a multiple reflection ToF mass analyser (MR-TOF) 150. The MR-TOF 150 is constructed around two opposing ion mirrors 160, 162, elongated in a drift direction. The mirrors are opposed in a direction that is orthogonal to the drift direction. The extraction trap 140 injects ions into the first mirror 160 and the ions then oscillate between the two mirrors 160, 162. The angle of ejection of ions from the extraction trap 140 and additional deflectors 170, 172 allow control of the energy of the ions in the drift direction, such that ions are directed down the length of the mirrors 160, 162 as they oscillate, producing a zig-zag trajectory. The mirrors 160, 162 themselves are tilted relative to one another, producing a potential gradient that retards the ions' drift velocity and causes them to be reflected back in the drift direction and focused onto a detector 180. The tilting of the opposing mirrors would normally have the negative side-effect of changing the time period of ion oscillations as they travel down the drift direction. This is corrected with one or more stripe electrode(s) 190 (to act as compensation electrode(s)) that alters the flight potential for a portion of the inter-mirror space, varying down the length of the opposing mirrors 160, 162. The combination of the varying width of the stripe electrode(s) 190 and variation of the distance between the mirrors 160, 162 allows the reflection and spatial focusing of ions onto the detector 180 as well as maintaining a good time focus. A suitable MR-TOF 150 for use in the present disclosure is further described in US-2015/028197-A1, the contents of which are hereby incorporated by reference in its entirety.

Ions accumulated in the extraction trap 140 are injected into the MR-TOF 150 as a packet of ions, once a predetermined number of ions have been accumulated in the extraction trap. By ensuring that each packet of ions injected into the MR-TOF 150 has at least a predetermined (minimum) number of ions, the resulting packet of ions arriving at the detector will be representative of the entire m/z range of interest of the MSⁿ spectrum. Accordingly, a single packet of fragmented ions can be enough to acquire an MSⁿ spectrum of the fragmented ions. This represent an increased sensitivity compared to conventional acquisition of ToF spectra in which multiple spectra typically are acquired and summed for each given m/z range segment. Preferably, a minimum total ion current (TIC) from each narrow m/z window is accumulated in the extraction trap before ejection to the ToF mass analyser. Preferably, at least N spectra (scans) are acquired per second in an MSⁿ domain by the ToF mass analyser, wherein N=50, or more preferably 100, or 200, or more.

Preferably, at least X % of the MSⁿ scans contain more than Y ion counts (wherein X=30, or 50, or 70, or most preferably 90, or more, and Y=200, or 500, or 1000, or 2000, or 3000, or 5000, or more). Most preferably, at least 90% of the MSⁿ scans contain more than 500 ion counts, or more preferably more than 1000 ion counts. This provides for an increased dynamic range of MSⁿ spectra. The desired ion counts for each of the MSⁿ scans may be provided by adjusting the number ions included in each packet of fragmented ions. For example, in the embodiment of FIG. 4, the accumulation time of the extraction trap may be adjusted to ensure that a sufficient number of ions have been accumulated. As such, the controller 195 (which is part of the mass spectrometry system 10, and which can control the operation of all components of the mass spectrometry system 10) may be configured to determine that a suitable packet of fragmented ions has been formed when either a predetermined number of ions are present in the extraction trap, or a predetermined period of time has passed. The predetermined period of time may be specified in order to ensure that the ToF mass analyser operates at the desired frequency, e.g., when the flow of ions to the extraction trap is relatively low.

The mass spectrometer 10 may be under the control of a controller 195 which, for example, is configured to control the timing of injection into and/or ejection from the trapping components, to set the appropriate potentials on the electrodes of the quadrupole etc., to focus and filter the ions, to capture the mass spectral data from the orbital trapping mass analyser 110, to capture the mass spectral data from the MR-TOF 150, control the sequence of MS¹, MS², and/or MS³ scans and so forth. It will be appreciated that the controller may comprise a computer that may be operated according to a computer program comprising instructions to cause the mass spectrometer to execute the steps of the method according to the disclosure.

It is to be understood that the specific arrangement of components shown in FIG. 4 is not essential to the methods subsequently described. Indeed, other arrangements for carrying out the DIA and other methods of embodiments of the present disclosure are suitable.

Nevertheless, in preferred embodiments, the first mass analyser may be a time-of-flight mass analyser, preferably a multi-reflection time-of-flight mass analyser. A ToF analyser may provide a good repetition rate to facilitate fast MS³ analysis. For instance, the first mass analyser may be configured to perform mass analysis at a repetition rate of at least 50 Hz or at least 100 Hz, or even as high as 200 Hz or more. The mass analyser may have various resolving powers. For example, the first mass analyser may have a resolving power of at least 1000, at least 3000, at least 10000 or at least 50000, or even higher.

In some embodiments, the mass spectrometry systems described herein may further comprise a second mass analyser. The second mass analyser could be provided downstream of the first mass filter, for instance. The second mass analyser may be an orbital trapping mass analyser, which provides a good compromise between cost, accuracy, sensitivity, repetition rate, etc. Nevertheless, other types of mass analyser can be used. The second mass analyser may be configured to perform MS¹ and/or MS² mass analysis; in such a case, the MSⁿ (where n is at least 3) analysis is preferably performed by the first mass analyser. In any event, it is preferred that the first mass analyser is able to and is configured to perform mass analysis at a higher repetition rate than the second mass analyser. This can be advantageous in controlling the timing in DIA.

In the foregoing, a method of performing MS¹ analysis with the orbital trapping analyser 110 and MS² with the ToF analyser 150 is principally described. In some embodiments, MS² analysis may be performed using the orbital trapping mass analyser 110 instead of the ToF analyser 150. In this mode of operation, sample ions (or, a m/z range segment of the sample ions within a m/z range of interest, selected by the quadrupole mass filter) may be analysed by the orbital trapping mass analyser 110 after fragmentation. In cases where the orbital trapping mass analyser performs MS² analysis, fragmented ions may be ejected from the fragmentation chamber 120 to the C-trap 100 and may be ejected from the C-trap 100 into the orbital trapping mass analyser 110. If one round of fragmentation takes place before the ions enter the orbital trapping mass analyser 110, then MS² mass spectral data may be obtained by the orbital trapping mass analyser 110. In some cases, one or more further rounds of fragmentation could be performed before analysis in the orbital trapping mass analyser 110.

### Additional Low-Cost Quadrupole for MS³ Analysis

The foregoing description of FIG. 4 explains principally how the mass spectrometry system 10 can be used in an MS¹ and MS² configuration, for example using the second trapping mass analyser 110. However, the addition of the further ion selection or mass selection device (e.g., the wide window quadrupole filter 135) and the high pressure region in extraction trap 140 (which can fragment ions) helps to provide a hybrid orbital trapping mass analyser/MR-ToF mass spectrometer, with high and low performance quadrupole mass filters in series, which is suitable for MS³ analysis or MSⁿ scans (using the ToF mass analyser for the MS³ or higher mass analysis).

Therefore, the embodiment of FIG. 4 can be described, in general terms, as a mass spectrometry system configured to perform MSⁿ mass spectrometry (where n is greater than or equal to 3), comprising: a first mass filter (e.g. the high performance quadrupole filter 70) having a first maximum resolution; a first fragmentation device (e.g. the ion routing multipole collision cell 120) downstream of the first mass filter and configured to fragment ions received from the first mass filter; a second mass filter (e.g. the wide window quadrupole filter 135) downstream of the first fragmentation device, the second mass filter having a second maximum resolution that is lower than the first maximum resolution; a second fragmentation device (e.g. a high pressure region within the extraction trap 140) downstream of the second mass filter; and a first mass analyser (e.g. the MR-ToF analyser 150) downstream of the second fragmentation device. The combination of two mass filters, with one being relatively low resolution, provides a quick, efficient and low-cost architecture for MSⁿ mass spectrometry. It will be appreciated that this general concept can be provided in different arrangements, with different types of mass filter, fragmentation device and mass analyser being provided.

As shown in FIG. 4, the hybrid mass spectrometer of U.S. Pat. No. 10,699,888-B2 can be enhanced by replacing the RF-only multipole ion guide between the analysers, with a low-resolution mass filter 135, which in this embodiment is a quadrupole mass filter. This may be akin to a quadrupole pre-filter as single segment, short (e.g., <10 cm or <15 cm) device, or may be longer and may include Brubaker pre-filters that enhance transmission. Unlike the high-performance mass filter 70, the low-resolution mass filter 135 does not require low micron-level electrode accuracy, and the whole assembly could be on the order of 20 μm level accuracy while still functioning well, for example. Resolving power without high losses of ˜100 can be achieved, to scan through ˜20Th windows. The second low-resolution quadrupole may therefore be significantly less costly than the higher-resolution quadrupole, and yet may be relatively resistant to contamination thanks to its lower overall performance requirements.

In generalised terms, the first maximum resolution (i.e., the maximum resolution with which the first mass filter can be configured without significant transmission loss) may be at least 250, at least 500, or at least 1000. It is preferred that the second maximum resolution (i.e., the maximum resolution with which the second mass filter can be configured without significant transmission loss) is less than 200, or less than 100. These values can be varied depending on the accuracy of the data that is required, provided that the first maximum resolution exceeds the second maximum resolution. The first mass filter and/or the second mass filter may be a quadrupole mass filter, a multipole (e.g., a hexapole or octupole) mass filter, or any other type of mass filter.

One or more performance characteristics of the first mass filter may exceed one or more respective performance characteristics of the second mass filter. That is, in addition to maximum resolution, other performance characteristics of the first mass filter may exceed corresponding characteristics of the second mass filter. For instance, the one or more performance characteristics may comprise any one or more of: mass accuracy; sensitivity; dynamic range; resolving power; mass stability; ion transmission efficiency; length; and mechanical tolerance. A preferred length of the second mass filter is less than 15 cm, less than 10 cm or less than 5 cm. Quadrupole mass filters made with such dimensions can be relatively low cost.

The approach of FIG. 4 has the advantage of working with no prolonged blockages of the ion beam required to pass ions back and forth. Previously, slow instrumentation and high ion losses meant that MS³ was only possible to perform in a targeted, data dependent manner. This includes triggering an MS³ scan based on the result of a prior MS and/or MS² scan, for example in the previously mentioned phosphopeptide analysis, where a fragment spectrum might be observed to be dominated by a single peak with a mass shift corresponding to neutral loss of a phosphate group.

Another area where a second isolation/fragmentation stage becomes valuable is with cross linking studies, where the linker is broken and then the separated components may be separated for sequencing. Similarly for techniques involving charge reduction, where an analyte is charge reduced (and undergoes backbone cleavage) via ETC/PTCR/ECD/EID and then a wide range of higher m/z fragments may be isolated and caused to undergo MS³ analysis.

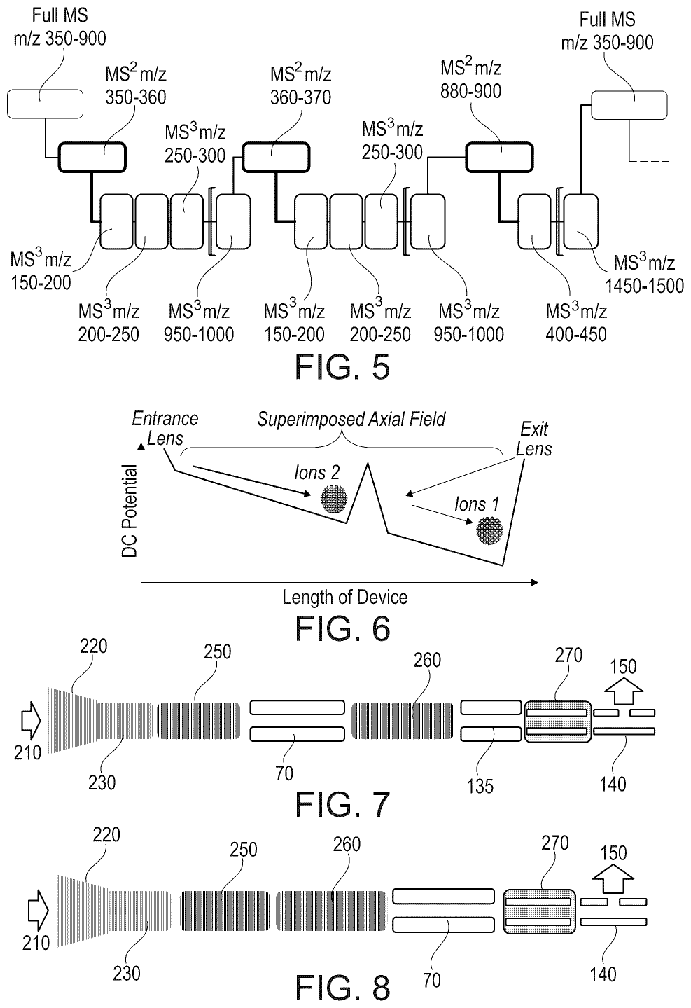

In accordance with the present disclosure, with fast analysers, such as a MR-ToF device in the architecture of FIG. 4, data independent acquisition (DIA) can be provided. FIG. 5 shows a DIA cycle, where the instrument scans through a series of preprogrammed full MS, MS² and MS³ acquisitions. As shown in FIG. 5, a repeating sequence of full MS scans is performed where each full MS scan encompasses a first m/z range of interest (e.g. 350-900 in the example of FIG. 5), e.g. with a rate compatible with chromatographic separation of the sample. For each full MS scan, a sequence of MS² scans is performed, where the (e.g. first) mass filter's (narrow) m/z isolation window is sequentially stepped through a second m/z range of interest (e.g. from 350-360 to 890-900 in steps of 10 in the example of FIG. 5). In addition, for each MS² scan, a sequence of MS³ scans is performed, where the (e.g. second) mass filter's (narrow) m/z isolation window is sequentially stepped through a third m/z range of interest (e.g. from 150-200 to 950-1000 in steps of 50 in the example of FIG. 5).

DIA typically involves relatively wide m/z isolation windows to scan sufficiently rapidly through the target m/z range even when limited to MS²; however, the 200 Hz acquisition that is achievable on current ToF analysers reduces this limitation. These difficulties return when MS³ is attempted, but since MS³ spectra are relatively sparse, relatively wide m/z isolation windows can be used, limiting the overall number of spectra per cycle. The scheme in FIG. 5, with 10Th MS² isolation windows and 50Th MS³ isolation windows, would still use 936 scans per cycle, but that is achievable with the arrangements disclosed herein. In generalised terms, in the DIA methods of the present disclosure, MS² may be performed with narrower isolation windows than MS³; for example, MS² may be performed with 10Th isolation windows and MS³ may be performed with 50Th isolation windows. The number of scans may be further limited by increasing the isolation window width of m/z regions with low ion flux (e.g., using the SWATH method, which could be performed based on information from full MS and/or MS² scans), or by varying the overall MS³ m/z range in line with the MS² fragment range. Low mass fragments, for example, will produce fewer high mass sub-fragments.

In embodiments of the present disclosure, in DIA applications, a relatively narrow m/z isolation window may be stepped across an entire m/z range of interest and each of those relatively narrow m/z isolation windows may be used for MS³ analysis.

For the hybrid orbital trapping mass analyser/MR-ToF spectrometer, the orbital trapping mass analyser may perform Full-MS scans, and optionally some/all of the MS² scans, which could also be shared with the MR-ToF analyser. The MS³ scans may all be performed by the MR-ToF analyser. In some embodiments, full MS or MS² scans may not be performed at all (i.e., the mass spectrometry system may perform only MS³ (or MSⁿ where n is greater than 3) analysis, and the orbital trapping mass analyser may be omitted).

Use of multiple MS³ scans per MS² scan may allow widening of the MS² isolation window, and a balance may be struck between isolation window width in both acquisition types. This may allow, for example, multiple TMT-labelled peptides per spectrum to be identified from a deliberately chimeric MS² analysis (with relatively wide, e.g., 2-4 Th, mass isolation windows in the first quadruple 70, ensuring high sensitivity and resilience to quadrupole contamination), whilst the ensuing series of MS³ analyses allows for low-interference quantitation, optionally with high fragmentation energy to maximise generation of reporter ions. A variant of this approach is to generate TMT MS² spectra as normal, but to then use the second quadrupole 135 to filter around the reporter region only (or complementary TMTc ions), and then analyse these target ions in the ToF 150 via a high resolution “zoom” mode (whereby ions are passed through the ToF analyser multiple times to increase its path length and therefore resolution, e.g. as described in GB 2,617,229 the contents of which are hereby incorporated by reference in their entirety), with no interferences from other ions. Isobaric TMTc ions in particular may require very high resolving powers to separate and quantify.

One or more of the analysis types (i.e. one or more of the MS2 scans and/or one or more of the MS3 scans) may performed in a data dependent acquisition (DDA) manner, i.e. based on data from the DIA scans to form a hybrid method.

In generalised terms, in some embodiments, the first fragmentation device may be configured to: receive first mass filtered ions from the first mass filter; fragment the first mass filtered ions to generate first fragment ions; and provide the first fragment ions to the second mass filter. The second mass filter may be configured to: mass filter the first fragment ions to provide second mass filtered ions; and provide the second mass filtered ions to the second fragmentation device. The second fragmentation device may be configured to fragment the second mass filtered ions to provide MSⁿ ions for the MSⁿ mass spectrometry.

The first fragmentation device may be a collision cell. Additionally or alternatively, the second fragmentation device may be a collision cell, such as a relatively high-pressure region of an extraction trap coupled to the first mass analyser. That is, the relatively high-pressure region of the extraction trap may be a region of the extraction trap that is at a higher pressure than some other region of the extraction trap. Any RF ion guide with a buffer gas can be used as the first and/or second fragmentation device if ions are injected with sufficient energy. A DC gradient is preferred to push ions along a fragmentation device. Details of such designs are shown in US-2023/0118221-A1, which is incorporated herein by reference. Alternative fragmentation methods may be used for either fragmentation device (or both fragmentation devices). For example, electron, chemical and photon-driven dissociation methods may be employed and these different mechanisms for fragmentation could also be combined.

### Reversing Ion Direction

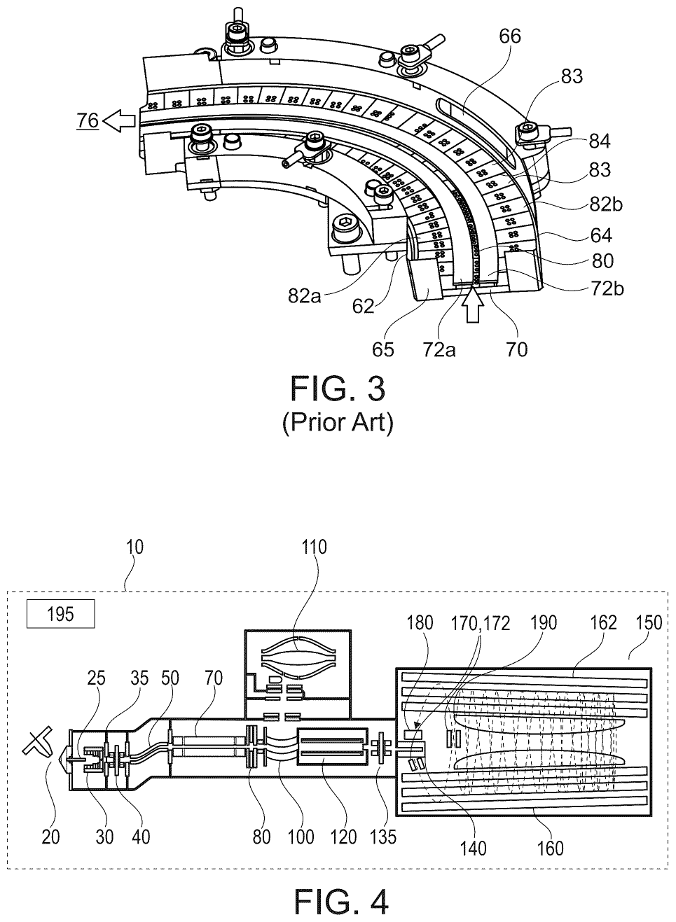

The hybrid analyser can be operated in a mode in which the direction of the ion path is reversed. This can provide MS³ analysis with only a single mass filter and a single mass analyser. For example, the ions may be turned back through the high-performance quadrupole 70, where they may be stopped within the bent flatapole 50 of FIG. 2 or FIG. 4 and again reversed/isolated/fragmented. Ions from the ion source 20 may be accumulated within the quadrupole pre-filter 30 during this period. In some embodiments, the axial field of the bent flatapole 50 may be split to create two distinct trapping regions. This may be accomplished by applying an additional DC voltage to one of the more central auxiliary DC electrodes (as shown in FIG. 3), which may then be removed from the resistive series, creating a controllable barrier in the linear gradient, as shown in FIG. 6. In some embodiments, the electrode may be kept within the resistive series and a triangular DC gradient may be formed, which pushes ions out to lenses on each side. As shown in FIG. 6, distinct regions for trapping ions can be provided upstream of the mass filter 70, which can be used to store ions and thereby facilitate MSⁿ (where n is at least 3) mass analysis.

Hence, in generalised terms, in some embodiments, the fragmentation device is configured to: receive (e.g., from an ion scheduling device) first mass filtered ions from the first mass filter; fragment the first mass filtered ions to generate first fragment ions; and provide (optionally via an ion scheduling device) the first fragment ions to the first mass filter. The first mass filter may be configured to mass filter the first fragment ions to provide second mass filtered ions. That is, the same mass filter may perform two separate steps of mass filtering. At this stage, the second mass filtered ions may optionally be passed to one or a plurality of ion scheduling devices for storage and separation. The fragmentation device may be configured to fragment the second mass filtered ions to provide MSⁿ ions for the MSⁿ mass spectrometry method. Such ions may subsequently be analysed by any mass analyser in the mass spectrometry system (e.g., a ToF analyser and/or an orbital trapping analyser). Moreover, such ions could be passed to one or a plurality of ion scheduling devices for storage and/or separation.

### Use of Ion Scheduling Devices

Ion scheduling devices (e.g., devices that can store ions and which are configured to separate ions according to a physico-chemical property correlated with mass-to-charge ratio) may also be used in embodiments of the present disclosure. In some embodiments, one ion scheduling device may be placed before a quadrupole mass filter (e.g., the mass filter 70 in FIG. 4) and used to synchronise the release of ions to the quadrupole isolation window, thereby reducing quadrupole ion losses. The same may be applied to a second quadrupole mass filter in MS³ analysis, with the ion scheduling device, e.g., merged into the fragmentation device/ion routing multiple and/or sitting between the fragmentation device/ion routing multipole and the second quadrupole. Such a layout is shown in FIG. 7.

In FIG. 7, ions are received via an ion inlet 210 and received at an ion collector or ion funnel 220 with a pre-accumulation region 230. A first ion scheduling device 250 receives the ions. A high-performance quadrupole mass filter (MS2) 70 is downstream of the first ion scheduling device 250. A second ion scheduling device 260 is downstream of the high-performance mass filter 70. The second ion scheduling device 260 is also configured to fragment ions (e.g., for MS² or MS³ analysis) and so may be described as a “Fragmentation and Ion Scheduling Device”. A low-performance quadrupole mass filter (MS3) 135 is provided downstream of the second ion scheduling device 260. A fragmentation cell 270 is downstream of the second ion scheduling device 260. The extraction device 140 and ToF analyser 150, which may be as described in respect of FIG. 4, are downstream of the fragmentation cell 270.

In the case of ions being passed back through the high-performance quadrupole 70, the second scheduling device 260 may be located between the first scheduling device 250 and a high-performance quadrupole 70, as shown in FIG. 8. FIG. 8 shows in-series ion scheduling devices, which can be used for efficient ion storage in pass-back MS³ analysis. Ions received from the ion source (via the inlet 210) can be stored (and separated) by the first ion scheduling device 250, while ions passed back from the fragmentation device 270 can be (simultaneously) stored (and separated) by the second ion scheduling device 260. In FIG. 8, the system operates in a similar way to the system of FIG. 7, but the low-performance mass filter 135 is omitted and ions can be passed back though the high-performance quadrupole 70 to allow subsequent performance of MS³ filtering and fragmentation. Moreover, in FIG. 8, there is no need for the second ion scheduling device 260 to be capable of fragmenting ions.

Referring back to FIG. 7, ions entering the vacuum system are first collected and pre-accumulated, then transferred to the first ion scheduling device 250 when it is available. FIG. 7 illustrates the use of ion scheduling devices to improve sensitivity of both MS² and MS³ acquisition. Ions are separated in the first ion scheduling device 250 and a desired first packet of ions released, which is then fragmented in the second scheduling device 260. The fragments are then themselves separated out and released in series for further isolation, fragmentation and mass analysis. Once the second fragmentation device 260 is emptied, a second ion packet may be released from the first scheduling device 250, and so on.

In FIG. 8, where the second scheduling device 260 is directly adjacent to the first scheduling device 250 (and may even be incorporated into the same assembly), the first ion packet is fragmented by the fragmentation device 270 and then the fragment ions are returned to the second scheduling device 260, where they are separated prior to release/isolation/fragmentation.

The embodiments of FIGS. 7-8 can be described, in generalised terms, as a mass spectrometry system configured to perform MSⁿ mass spectrometry (where n is greater than or equal to 3), comprising: a first mass filter (e.g., the low-performance quadrupole 135 in FIG. 7, or the high performance quadrupole 70 in FIG. 8); a fragmentation device (e.g., the fragmentation cell 270 in FIGS. 7-8) downstream of the first mass filter and configured to fragment ions received from the first mass filter; a first mass analyser (e.g., the ToF analyser 150) downstream of the first mass filter (and optionally also downstream of a fragmentation device); a first device (e.g., the first ion scheduling device 250) configured to separate ions according to a first physico-chemical property correlated with mass-to-charge ratio, wherein the first device configured to separate ions is upstream of the first mass filter; and a second device (e.g., the second ion scheduling device 260) configured to separate ions according to a second physico-chemical property correlated with mass-to-charge ratio, wherein the second device configured to separate ions is upstream of the first mass filter. Throughout this disclosure, the expression “ion scheduling device” is used interchangeably with the expression “device configured to separate ions according to a first physico-chemical property correlated with mass-to-charge ratio”.

In some embodiments of the present disclosure, a first device configured to separate ions according to a first physico-chemical property correlated with mass-to-charge ratio may be provided upstream of the first mass filter (e.g., mass filter 70). Such a device configured to separate ions may be configured to provide ions (directly or via intermediate components) to the first mass filter in (ascending or descending) order of the first physico-chemical property. Effectively, ions that enter such a device may be stored and sorted according to a physico-chemical property. The first physico-chemical property could be ion mobility or mass-to-charge ratio, or some other property correlated with mass-to-charge ratio.

In some embodiments, a second device configured to separate ions according to a second physico-chemical property correlated with mass-to-charge ratio may be provided upstream of the first mass filter. Again, such a second device may be configured to provide (directly or via intermediate components) ions to the first mass filter in (ascending or descending) order of the second physico-chemical property. The second device configured to separate ions may be provided downstream of (i.e., further from an ion source) the first device configured to separate ions; the first and second devices may be in series. The second device may be configured to separate ions received from the fragmentation device. The second physico-chemical property may also be ion mobility or mass-to-charge ratio, or some other property. Where first and second devices configured to separate ions are provided, they can be identical, or they can be different. For example, one might separate ions according to m/z while the other might separate ions according to mobility.

One or both of the first device configured to separate ions and/or the second device configured to separate ions may further be configured to fragment ions. For example, a gas pressure in the device(s) might be high enough to cause fragmentation when ions with sufficient kinetic energy collide with and/or move through the gas.

Where two or more mass filters are present, at least one mass filter (e.g. the high performance mass filter 70 in FIG. 7) may be arranged between the first device configured to separate ions and the second device configured to separate ions. In such arrangements, a relatively low-performance mass filter (e.g. mass filter 135) may be described as a first mass filter that is arranged downstream of the first device configured to separate ions and the second device configured to separate ions. An example of such an arrangement is shown in FIG. 7, for instance.

In some embodiments, a second mass filter may be arranged between the second device configured to separate ions and the first mass analyser. Such an arrangement is also shown in FIG. 7. The first mass filter may be downstream of the first device configured to separate ions and/or the second mass filter may be downstream of the second device configured to separate ions. Such arrangements provide convenient ways of processing ions for MSⁿ analysis.

In embodiments where the instrument includes one or more ion scheduling device(s), each ion scheduling device may be operated in order of the respective physico-chemical property and/or in synchronism with a respective downstream mass filter. In particular, when the instrument is performing a DIA method (where, as described above, the first and/or second mass filter's (narrow) m/z isolation window is sequentially stepped through a m/z range of interest), the ion scheduling device may be operated such that packets of ions are released to the mass filter that have a range of m/z that corresponds to (i.e. that is the same as or is similar to) the mass filter's current isolation window. This has the effect of substantially reducing ion losses caused by the mass filtering, thereby increasing the overall sensitivity of the instrument.

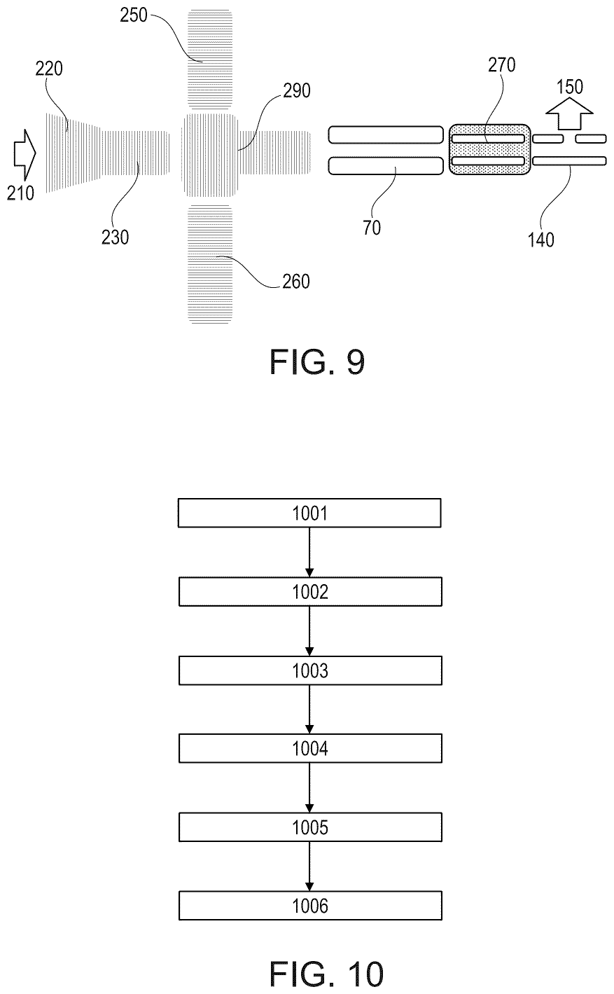

MS² analysis may be performed with the same ion load that is used for MS³. One issue occurs with interleaved full MS scans is that these typically require only short ion accumulation times, but the single inline pre-accumulation region is typically bound to the long processing cycle of the ion scheduler, resulting in considerable wasted beam time. Therefore, it may be advantageous in some embodiments to have parallel accumulation regions, beam switches and/or bypasses so that the ions may be accumulated without completely blocking the direct ion path from the source, as shown in FIG. 9.

In some embodiments, the pre-accumulation region 230 may accumulate while the downstream scheduling device is operating and thus blocked. Since the typical accumulation time for MS1 is very low, there may be significant dead time where an ion scheduler is blocked, but the pre-accumulation region is as full as the next scan requires it to be, so the remaining ion beam during this time may be wasted. In such cases, it may become advantageous to provide a second pre-accumulation region so that the loading for the scan after the next MS1 scan can begin, or alternatively the ability to accumulate without blocking the path for a relatively quick MS1 scan.

FIG. 9 shows the incorporation of a beam switching device, so that ions may be accumulated/separated in multiple positions without necessarily blocking the direct ion path from the source to the mass analyser.

In FIG. 9, ions are received via an ion inlet 210 and received at an ion collector or ion funnel 220 with a pre-accumulation region 230. A beam switching device 290 is provided in the ion path, downstream of the pre-accumulation region 230 and upstream of the high-performance mass filter 70. The beam switching device 290 can provide ions to either of the first and second ion scheduling devices 250 and 260 or can permit ions to pass along the ion path without entering either of the ion scheduling devices 250 and 260 (and hence can act as a bypass). A fragmentation cell 270 is downstream of the high-performance mass filter 70. The extraction device 140 and ToF analyser 150, which may be as described in respect of FIG. 4, are downstream of the fragmentation cell 270. The addition of the beam switching device 290 provides further flexibility and control when transporting ions to different regions for MS³ (or higher) analysis.

Suitable beam switching devices may be based on RF carpets with beam direction controlled by DC gradients (which may be non-linear), time-varying potentials (e.g., RF carpets with repulsive RF pseudopotentials) and/or travelling waves (T-waves). Examples of suitable hardware are disclosed in GB2209555.8 (which describes suitable beam switching devices) and GB2312733.5 (which describes suitable ion scheduling devices), for instance, which are both incorporated herein by reference. In the context of the hybrid analyser, it may be advantageous to have one branch of the ion path headed to the orbital trapping mass analyser for full MS, whilst another branch of the ion path heads from an ion source to the ToF analyser via an ion scheduling device (or ion scheduling devices). In some cases, a third mass analyser might be provided in one branch or the other, or in a separate branch.

Accordingly, in generalised terms, some embodiments of the disclosure comprise an ion inlet for receiving ions from an ion source, the mass spectrometry system defining an ion path between the ion inlet and the first mass analyser. A beam switching device may be provided in the ion path. The beam switching device may define a node in the ion path. One or both of a first device configured to separate ions and/or a second device configured to separate ions may be coupled to (i.e., capable of transferring ions to and from) the beam switching device. The beam switching device may selectively provide ions to different regions of the mass spectrometry system that are coupled to the beam switching device. For instance, the beam switching device may be configured to selectively (e.g., by controlling voltages applied to electrodes) provide ions to a first device configured to separate ions and/or to a second device configured to separate ions. Hence, a beam switching device can facilitate the transferring of ions to different components of the mass spectrometer. In some cases, the beam switching device may be configured to permit ions to travel along the ion path without passing through the first device configured to separate ions and/or the second device configured to separate ions; thus, the beam switching devices described herein may also serve to bypass ions to prevent ions entering one or both of the devices configured to separate ions.

The beam switching device(s) disclosed herein can be described, in general terms, as an ion guide with a switchable ion path for a spectrometer. The ion guide comprises a first ion transport aperture configured to receive an ion beam. The ion guide comprises a radio frequency (RF) surface comprising a plurality of radio frequency electrodes arranged on a first surface, such that the plurality of RF electrodes are parallel to each other. The RF surface may also be referred to as a radio frequency carpet. The ion guide further comprises a radio frequency voltage source configured to apply an alternating radio frequency phase to each of the plurality of RF electrodes. The ion guide further comprises a DC potential source configured to apply a DC gradient across the RF surface, wherein the DC gradient is configured to guide an ion beam via either a first ion path or a second ion path or one or more further ion path(s). The ion guide further comprises a second ion transport aperture and a third ion transport aperture, wherein ions travelling in the first ion path are directed to the second ion transport aperture and ions travelling in the second ion path are directed to the third ion transport aperture.

In use, the ion guide may be configured to receive an ion beam via the first ion transport aperture. The DC gradient may be configured to guide the ion beam via either the first ion path or the second ion path (or a further ion path), such that the ions of the ion beam exit the ion guide via either the second ion transport aperture or the third ion transport aperture (or a further ion transport aperture). The DC gradient may be configured to split the ion beam into a first portion and a second portion (and/or a further portion), and to guide the first portion of the ion beam along the first ion path (such that the first portion exits the ion guide via the second ion transport aperture) and the second portion of the ion beam along the second ion path (such that the second portion exits the ion guide via the third ion transport aperture) (and optionally to guide a further portion along a further ion path). Otherwise, the ion guide may be configured to receive an ion beam via the second ion transport aperture and/or the third ion transport aperture. The DC gradient may be configured to guide ions entering the ion guide via the second ion transport aperture along an ion path such that the ions are directed to the first or further ion transport aperture and exit the ion guide via the first or further ion transport aperture. The DC gradient may be configured to guide ions entering the ion guide via the third ion transport aperture along an ion path such that the ions are directed to the first or further ion transport aperture and exit the ion guide via the first or further ion transport aperture. Hence, the beam switching devices herein can provide switchable ion paths to provide improved control over ions.

Methods of using the above-described mass spectrometry systems are also provided. For example, FIG. 10 shows, in generalised terms, a method of performing MSⁿ mass spectrometry, where n is greater than or equal to 3. The method comprises: providing 1001 a sample of ions to any of the mass spectrometry systems described herein that comprise a first and second mass filter; performing a first mass filtering 1002 on the ions using the first mass filter to provide first mass filtered ions; performing a first fragmentation 1003 on the first mass filtered ions using the first fragmentation device to generate first fragment ions; performing a second mass filtering 1004 on the first fragment ions using the second mass filter to provide second mass filtered ions; performing a second fragmentation 1005 on the second mass filtered ions using the second fragmentation device to provide second fragmented ions; and performing the MSⁿ mass analysis 1006 on the second fragmented ions using the first mass analyser.

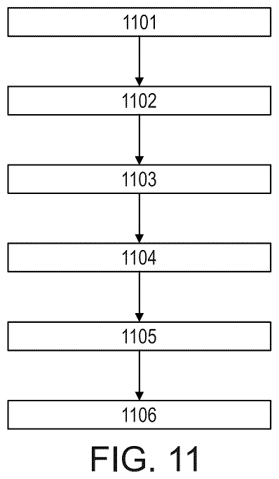

Similarly, FIG. 11 shows a further generalised method of performing MSⁿ mass spectrometry, where n is greater than or equal to 3. The method comprises: providing 1101 a sample of ions to any of the above-described mass spectrometry systems that perform pass-back methods; performing a first mass filtering 1102 on the ions using the first mass filter to provide first mass filtered ions; performing a first fragmentation 1103 on the first mass filtered ions using the fragmentation device to generate first fragment ions; performing a second mass filtering 1104 on the first fragment ions using the first mass filter to provide second mass filtered ions; performing a second fragmentation 1105 on the second mass filtered ions using the fragmentation device to provide second fragmented ions; and performing MSⁿ mass analysis 1106 on the second fragmented ions using the first mass analyser.

Between the different stages of mass filtering and fragmentation, ions may be transferred into one or a plurality of ion scheduling devices. For instance, prior to performing the first mass filtering, ions may be provided to the first mass filter via one or both of the first device configured to separate ions and the second device configured to separate ions. Additionally or alternatively, prior to performing the second mass filtering, ions may be provided to the first mass filter via one or both of the first device configured to separate ions and the second device configured to separate ions. Beam switching devices may also be provided in the ion path to transfer ions to appropriate regions of the mass spectrometry system.

In the mass spectrometry systems described herein, the mass spectrometry systems may be configured to perform MSⁿ mass spectrometry in a data independent acquisition mode. Moreover, the mass spectrometry systems may be configured to perform tandem mass-tagging (TMT) analysis.

As mentioned previously, various devices can be used as ion scheduling devices or devices configured to separate ions according to physico-chemical properties thereof. For example, in some embodiments, the first device configured to separate ions and/or the second device configured to separate ions may comprise: a separation region configured to receive the ions, the separation region extending in a first direction; and an electrode arrangement configured to confine the ions in the separation region, wherein the electrode arrangement is configured to: apply a time-varying potential in the separation region to cause the ions to move in the first direction; and apply a potential gradient in the separation region, the potential gradient opposing the time-varying potential, such that the ions are separated at different positions in the first direction according to the mass-to-charge ratios of the ions.

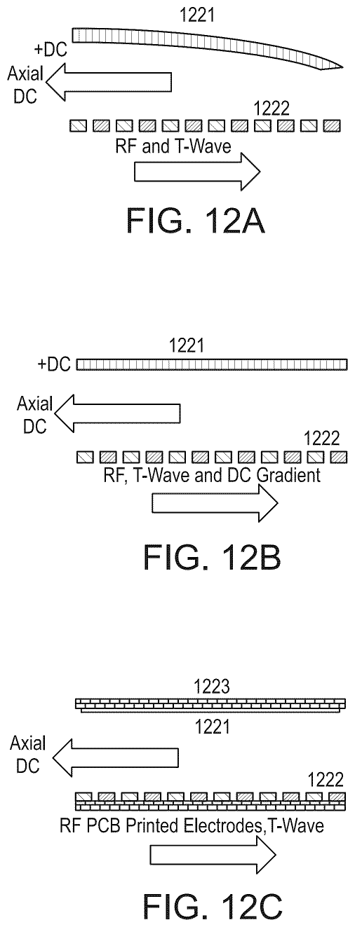

FIGS. 12A-12C show some embodiments of suitable electrode arrangements for ion scheduling devices. FIGS. 12A-12C show examples of RF carpet device layouts suitable for application of both travelling wave (or other time-varying potentials) and an opposing DC. In some embodiments, T-Waves are applied on trapping RF electrodes, because whilst it is possible to apply a travelling wave to a counter electrode (if suitably segmented), the ions generally sit closer to the RF electrodes and a top-down travelling wave will be greatly smoothed out. The opposing axial DC may be provided by other electrodes on the same surface of the separation device as the RF electrodes, but may also be sourced from the counter electrode, either by changing the distance of the electrode from the RF carpet, or by segmentation and application of suitably divided DC potential.

The various electrode arrangements of FIGS. 12A-12C include a counter electrode 1221 and RF electrodes 1222. In FIGS. 12A-12C, each of the counter electrodes 1221 opposes the RF electrodes 1222. The electrode arrangements of FIGS. 12A-12C are ion carpet style structures for application of both travelling wave (applied to RF electrodes 1222) and opposing axial DC sourced from shaped counter electrode 1221 (FIG. 12A), segmented RF electrodes 1222 (FIG. 12B) and segmented counter-electrode 1221 (FIG. 12C). Combinations of these three options can be provided.

In FIG. 12A, an axial DC provided by the shaped counter electrode opposes T-Waves provided by the RF electrodes 1222. RF potentials can provide confinement in the up/down direction. In FIG. 12B, the RF electrodes 1222 have RF, T-Wave and DC gradient applied. In FIG. 12C, the counter electrode 1221 is provided on a PCB 1223 and comprises printed electrodes with a resistive DC gradient, while the RF electrodes 1222 are RF PCB printed electrodes that apply a T-Wave.

FIGS. 12A-12C only show cross-sections of the electrode arrangement in a single plane. The electrode arrangements of FIGS. 12A-12C may be configured such that ions are able to move in a direction perpendicular to the plane of the cross sections.

It will be understood that FIGS. 12A-12C show specific embodiments of electrodes for use in ion scheduling devices and that other devices can be used. For instance, SLIM devices and/or trap accumulators can be used instead of and/or in addition to such opposing T-Wave/DC arrangements.

Various possibilities exist for how the electrodes of ion scheduling devices may be configured. For example, the ion scheduling devices may apply time-varying potentials in the separation region. The time-varying potentials may comprise any one or more of: an oscillatory potential; an RF potential; a pseudopotential that varies in the first direction; a travelling wave; and a DC travelling wave. The potential gradient and/or the time-varying potential may vary non-linearly in the first direction. The potential gradient may be a DC potential gradient. The electrode arrangement may comprise a first set of one or more electrodes configured to apply the potential gradient and a second set of one or more electrodes configured to apply the time-varying potential. The first and second sets of one or more electrodes may be on opposite sides of the separation region; and/or the first set of one or more electrodes may be substantially parallel with the second set of one or more electrodes; and/or the first set of one or more electrodes may be substantially planar and/or the second set of one or more electrodes is substantially planar; and/or the first and/or second set of one or more electrodes may comprise a plurality of electrodes; and/or the first and/or second set of one or more electrodes may comprise a plurality of electrode segments; and/or the first and/or second set of one or more electrodes may be on a printed circuit board, PCB; and/or the first and second sets of one or more electrodes can be substantially coplanar.

The first set of one or more electrodes may comprise a counter electrode, where: the counter electrode is a shaped counter-electrode, wherein the potential gradient has a shape corresponding to the shaped counter-electrode; and/or a distance between the first set of one or more electrodes and the second set of one or more electrodes varies along a length of the separation region.

Hence, the arrangements of FIGS. 12A-12C can be used to store ions and separate ions according to physico-chemical properties of the ions. They can therefore be used to improve the operation of the mass spectrometer of FIG. 4, by acting as the ion scheduling devices 250 and 260.

Other types of suitable ion scheduling device include ion mobility separators. An ion mobility separator may be configured to separate ions according to their ion mobility. Any suitable type of ion mobility separator may be used. For example, an electric field, such as a DC voltage gradient and/or a travelling DC voltage wave, may be arranged to urge ions along the length of a separation region through a gas, so that the ions are separated according to their ion mobility. Ions may optionally be urged against a counter flow of gas or perpendicularly to it. Alternatively, a gas flow may be arranged to urge ions along the length of a separation region, while an electric field, such as a DC voltage gradient and/or a travelling DC voltage wave, may be arranged to oppose the gas flow so that the ions are separated according to their ion mobility. The ion mobility separator may be a linear separator with a straight or folded path or a cyclic (closed-loop) separator.

In some embodiments, a sufficiently high performing ion scheduling device can be used to eliminate a quadrupole mass filter, as a high performance ion scheduling device may be capable of isolating ions to a sufficient quality by itself. This may remove the need for at least one mass filter, e.g. the low performance quadrupole 135. Some ion scheduling devices, such as SLIM, may be capable of isolating to the minimum level of a high performance quadrupole mass filter. Accordingly, in the embodiments described above, the first mass filter may comprise a first device configured to separate ions according to a first physico-chemical property correlated with mass-to-charge ratio. Additionally or alternatively, the second mass filter may comprise a second device configured to separate ions according to a second physico-chemical property correlated with mass-to-charge ratio.

A number of embodiments of this disclosure include devices configured to separate ions according to a physico-chemical property (e.g. ion mobility or mass-to-charge ratio). Such devices may have peak capacity (which may be defined as the maximum number of resolvable peaks by a given separation method) of at least 10, at least 20, at least 50 or at least 100. Any of the first and/or second devices 250 and 260 in FIGS. 7-9 may have such peak capacities and the arrangements shown in FIGS. 12A-12C may have such peak capacities. Additionally or alternatively, such devices may have resolving power of at least 10, at least 20, at least 50 or at least 100.

Hence, it can be seen that the disclosure provides a number of advantages over conventional mass spectrometry systems. For example, the use of a high-performance mass filter for MS² filtering and a lower performance filter for MS³ allows MS³ to be performed on relatively low-cost and low-complexity devices. Furthermore, DIA methods performed on such hardware may be highly efficient, particularly when implemented in hybrid mass analysers that incorporate an orbital trapping mass analyser and MR-ToF analyser.

Moreover, the use of multiple ion scheduling devices upstream of a mass filter provides good control over ion delivery and can reduce ion losses, which may be particularly useful in MS³ scans, and particularly helps to restrain ion losses in DIA processes. The idea of synchronising such a device to a quadrupole filter and the use of a pair of such devices and the application to MS³ is highly advantageous. The use beam switching devices to control the bypassing of such devices can also be highly advantageous.

The following clauses defines examples of embodiments according to the disclosure.

1. A mass spectrometry system configured to perform MSⁿ mass spectrometry, where n is greater than or equal to 3, the mass spectrometry system comprising: a first mass filter having a first maximum resolution; a first fragmentation device downstream of the first mass filter and configured to fragment ions received from the first mass filter; a second mass filter downstream of the first fragmentation device, the second mass filter having a second maximum resolution that is lower than the first maximum resolution; a second fragmentation device downstream of the second mass filter; and a first mass analyser downstream of the second fragmentation device.

2. The mass spectrometry system of clause 1, wherein: the first maximum resolution is at least 250, at least 500, or at least 1000; and/or the second maximum resolution is less than 200, or less than 100.

3. The mass spectrometry system of any preceding clause, wherein one or more performance characteristics of the first mass filter exceed one or more respective performance characteristics of the second mass filter, the one or more performance characteristics comprising any one or more of: mass accuracy; sensitivity; dynamic range; resolving power; mass stability; ion transmission efficiency; length; and mechanical tolerance.

4. The mass spectrometry system of any preceding clause, wherein a length of the second mass filter is less than 15 cm, less than 10 cm or less than 5 cm.

5. The mass spectrometry system of any preceding clause, wherein: the first fragmentation device is configured to: receive first mass filtered ions from the first mass filter; fragment the first mass filtered ions to generate first fragment ions; and provide the first fragment ions to the second mass filter; and/or the second mass filter is configured to: mass filter the first fragment ions to provide second mass filtered ions; and provide the second mass filtered ions to the second fragmentation device; and/or the second fragmentation device is configured to fragment the second mass filtered ions to provide MSⁿ ions for the MSⁿ mass spectrometry.

6. The mass spectrometry system of any preceding clause, wherein: the first fragmentation device is a collision cell; and/or the second fragmentation device is a collision cell, preferably wherein the second fragmentation device is a relatively high-pressure region of the first mass analyser.

7. The mass spectrometry system of any preceding clause, wherein the first mass filter and/or the second mass filter is a quadrupole mass filter or a multipole mass filter.

8. The mass spectrometry system of any preceding clause, wherein: the first mass filter comprises a first device configured to separate ions according to a first physico-chemical property correlated with mass-to-charge ratio; and/or the second mass filter comprises a second device configured to separate ions according to a second physico-chemical property correlated with mass-to-charge ratio.

9. The mass spectrometry system of any preceding clause, further comprising a first device configured to separate ions according to a first physico-chemical property correlated with mass-to-charge ratio, wherein the first device configured to separate ions is upstream of the first mass filter, preferably wherein the first device configured to separate ions is configured to provide ions to the first mass filter in order of the first physico-chemical property, preferably wherein the first device is operated in synchronism with the first mass filter.

10. The mass spectrometry system of clause 9, further comprising a second device configured to separate ions according to a second physico-chemical property correlated with mass-to-charge ratio, wherein the second device configured to separate ions is upstream of the second mass filter, preferably wherein the second device configured to separate ions is configured to provide ions to the second mass filter in order of the second physico-chemical property, preferably wherein the second device is operated in synchronism with the second mass filter.

11. The mass spectrometry system of clause 10, wherein the second device configured to separate ions is downstream of the first mass filter.

12. A mass spectrometry system configured to perform MSⁿ mass spectrometry, where n is greater than or equal to 3, the mass spectrometry system comprising: a first mass filter; a fragmentation device downstream of the first mass filter and configured to fragment ions received from the first mass filter; a first mass analyser downstream of the first mass filter; a first device configured to separate ions according to a first physico-chemical property correlated with mass-to-charge ratio, wherein the first device configured to separate ions is upstream of the first mass filter; and a second device configured to separate ions according to a second physico-chemical property correlated with mass-to-charge ratio, wherein the second device configured to separate ions is upstream of the first mass filter.

13. The mass spectrometry system of clause 12, wherein: the first device is configured to separate ions received from an ion source arranged upstream of the first device; and the second device is configured to separate ions received from the fragmentation device.

14. The mass spectrometry system of clause 12 or 13, wherein the second device configured to separate ions is downstream of the first device configured to separate ions.

15. The mass spectrometry system of clause 12, 13 or clause 14, wherein the first device configured to separate ions and/or the second device configured to separate ions is configured to provide ions to the first mass filter in order of the first physico-chemical property and/or the second physico-chemical property respectively, preferably wherein the first device and/or the second device is configured to be operated in synchronism with the first mass filter.

16. The mass spectrometry system of any of clauses 12 to 15, further comprising: an ion inlet for receiving ions from an ion source, the mass spectrometry system defining an ion path between the ion inlet and the first mass analyser; and a beam switching device in the ion path, wherein the first device configured to separate ions and/or the second device configured to separate ions is coupled to the beam switching device.

17. The mass spectrometry system of clause 16, wherein: the beam switching device is configured to selectively provide ions to the first device configured to separate ions and/or to the second device configured to separate ions; and/or the beam switching device is configured to permit ions to travel along the ion path without passing through the first device configured to separate ions and/or the second device configured to separate ions.

18. The mass spectrometry system of any of clauses 12 to 17, wherein: the fragmentation device is configured to: receive first mass filtered ions from the first mass filter; fragment the first mass filtered ions to generate first fragment ions; and provide the first fragment ions to the first mass filter; and/or the first mass filter is configured to mass filter the first fragment ions to provide second mass filtered ions; and/or the fragmentation device is configured to fragment the second mass filtered ions to provide MSⁿ ions for the MSⁿ mass spectrometry.

19. The mass spectrometry system of any of clauses 8 to 18, wherein the first physico-chemical property is ion mobility or mass-to-charge ratio and/or wherein the second physico-chemical property is ion mobility or mass-to-charge ratio.

20. The mass spectrometry system of any of clauses 8 to 19, wherein the first device configured to separate ions and/or the second device configured to separate ions is further configured to fragment ions.

21. The mass spectrometry system of any of clauses 8 to 20, wherein the first device configured to separate ions and/or the second device configured to separate ions comprises: a separation region configured to receive the ions, the separation region extending in a first direction; and an electrode arrangement configured to confine the ions in the separation region, wherein the electrode arrangement is configured to: apply a time-varying potential in the separation region to cause the ions to move in the first direction; and apply a potential gradient in the separation region, the potential gradient opposing the time-varying potential, such that the ions are separated at different positions in the first direction according to the mass-to-charge ratios of the ions.

22. The mass spectrometry system of any preceding clause, wherein the mass spectrometry system is configured to perform the MSⁿ mass spectrometry in a data independent acquisition mode.

23. The mass spectrometry system of any preceding clause, wherein the mass spectrometry system is configured to perform tandem mass-tagging (TMT) analysis.

24. The mass spectrometry system of any preceding clause, wherein: the first mass analyser is a time-of-flight mass analyser, preferably a multi-reflection time-of-flight mass analyser; and/or the first mass analyser has a resolving power of at least 1000, at least 3000, at least 10000 or at least 50000; and/or the first mass analyser is configured to perform mass analysis at a repetition rate of at least 50 Hz or at least 100 Hz.

25. The mass spectrometry system of any preceding clause, further comprising a second mass analyser, preferably wherein the second mass analyser is an orbital trapping mass analyser.

26. The mass spectrometry system of clause 25, wherein the first mass analyser is configured to perform mass analysis at a higher repetition rate than the second mass analyser.

27. The mass spectrometry system of clause 25 or clause 26, wherein: the second mass analyser is configured to perform MS¹ and/or MS² mass analysis; and/or the first mass analyser is configured to perform MSⁿ mass analysis.

28. A method of performing MSⁿ mass spectrometry, where n is greater than or equal to 3, the method comprising: providing a sample of ions to the mass spectrometry system of any of clauses 1 to 27, when dependent on clause 1; performing a first mass filtering on the ions using the first mass filter to provide first mass filtered ions; performing a first fragmentation on the first mass filtered ions using the first fragmentation device to generate first fragment ions; performing a second mass filtering on the first fragment ions using the second mass filter to provide second mass filtered ions; performing a second fragmentation on the second mass filtered ions using the second fragmentation device to provide second fragmented ions; and performing MSⁿ mass analysis on the second fragmented ions using the first mass analyser.

29. A method of performing MSⁿ mass spectrometry, where n is greater than or equal to 3, the method comprising: providing a sample of ions to the mass spectrometry system of any of clauses 13 to 27, when dependent on clause 12; performing a first mass filtering on the ions using the first mass filter to provide first mass filtered ions; performing a first fragmentation on the first mass filtered ions using the fragmentation device to generate first fragment ions; performing a second mass filtering on the first fragment ions using the first mass filter to provide second mass filtered ions; performing a second fragmentation on the second mass filtered ions using the fragmentation device to provide second fragmented ions; and performing MSⁿ mass analysis on the second fragmented ions using the first mass analyser.

30. The method of clause 29, wherein: prior to performing the first mass filtering, ions are provided to the first mass filter via one or both of the first device configured to separate ions and the second device configured to separate ions; and/or prior to performing the second mass filtering, ions are provided to the first mass filter via one or both of the first device configured to separate ions and the second device configured to separate ions.

In this disclosure, where a first device is described as being downstream of a second device, this may mean that the first device is capable of receiving ions from the second device and that the ions pass through the second device before they pass through the first device. That is, in such a case, the second device may be closer to an ion source than the first device is. It should also be noted that where a first device is described as being downstream of a second device, one or more intermediate components may be positioned between the first and second devices. Conversely, where a first device is described as being upstream of a second device, this may mean that the second device is capable of receiving ions from the first device and that the ions pass through the second device after they pass through the first device. The downstream direction(s) may generally be considered to be the direction(s) in which ions travel from the ion source to the mass analyser(s).

It will be understood that many variations may be made to the above systems and methods whilst retaining the advantages noted previously. For example, where specific components have been described, alternative components can be provided that provide the same or similar functionality.

Each feature disclosed in this specification, unless stated otherwise, may be replaced by alternative features serving the same, equivalent or similar purpose. Thus, unless stated otherwise, each feature disclosed is one example only of a generic series of equivalent or similar features.

As used herein, including in the claims, unless the context indicates otherwise, singular forms of the terms herein are to be construed as including the plural form and, where the context allows, vice versa. For instance, unless the context indicates otherwise, a singular reference herein including in the claims, such as “a” or “an” (such as a fragmentation device or a mass filter) means “one or more” (for instance, one or more fragmentation devices, or one or more mass filters). Throughout the description and claims of this disclosure, the words “comprise”, “including”, “having” and “contain” and variations of the words, for example “comprising” and “comprises” or similar, mean that the described feature includes the additional features that follow, and are not intended to (and do not) exclude the presence of other components.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

Any steps described in this specification may be performed in any order or simultaneously unless stated or the context requires otherwise. Moreover, where a step is described as being performed after a step, this does not preclude intervening steps being performed.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

We claim:

1. A mass spectrometry system configured to perform MSⁿ mass spectrometry, where n is greater than or equal to 3, the mass spectrometry system comprising:
a first mass filter having a first maximum resolution;
a first fragmentation device downstream of the first mass filter and configured to fragment ions received from the first mass filter;
a second mass filter downstream of the first fragmentation device, the second mass filter having a second maximum resolution that is lower than the first maximum resolution;
a second fragmentation device downstream of the second mass filter; and
a first mass analyser downstream of the second fragmentation device.

2. The mass spectrometry system of claim 1, wherein one or both of:
(i) the first maximum resolution is at least 250, at least 500, or at least 1000; and
(ii) the second maximum resolution is less than 200, or less than 100.

3. The mass spectrometry system of claim 1, wherein one or more performance characteristics of the first mass filter exceed one or more respective performance characteristics of the second mass filter, the one or more performance characteristics comprising any one or more of: mass accuracy; sensitivity; dynamic range; resolving power; mass stability; ion transmission efficiency; length; or mechanical tolerance.

4. The mass spectrometry system of claim 1, wherein a length of the second mass filter is less than 15 cm.

5. The mass spectrometry system of claim 1, wherein one or more of:
(i) the first fragmentation device is configured to:
receive first mass filtered ions from the first mass filter;
fragment the first mass filtered ions to generate first fragment ions; and
provide the first fragment ions to the second mass filter;
(ii) the second mass filter is configured to:
mass filter the first fragment ions to provide second mass filtered ions; and
provide the second mass filtered ions to the second fragmentation device; or
(iii) the second fragmentation device is configured to fragment the second mass filtered ions to provide MSⁿ ions for the MSⁿ mass spectrometry.

6. The mass spectrometry system of claim 1, wherein one or both of:
(i) the first fragmentation device is a collision cell; and
(ii) the second fragmentation device is a collision cell.

7. The mass spectrometry system of claim 1, wherein one or both of the first mass filter and the second mass filter is a quadrupole mass filter or a multipole mass filter.

8. The mass spectrometry system of claim 1, wherein one or both of:
(i) the first mass filter comprises a first device configured to separate ions according to a first physico-chemical property correlated with mass-to-charge ratio; and
(ii) the second mass filter comprises a second device configured to separate ions according to a second physico-chemical property correlated with mass-to-charge ratio.

9. The mass spectrometry system of claim 1, further comprising a first device configured to separate ions according to a first physico-chemical property correlated with mass-to-charge ratio, wherein the first device configured to separate ions is upstream of the first mass filter.

10. The mass spectrometry system of claim 9, further comprising a second device configured to separate ions according to a second physico-chemical property correlated with mass-to-charge ratio, wherein the second device configured to separate ions is upstream of the second mass filter.

11. The mass spectrometry system of claim 10, wherein the second device configured to separate ions is downstream of the first mass filter.

12. The mass spectrometry system of claim 8, wherein one or both of:
(i) the first physico-chemical property is ion mobility or mass-to-charge ratio, and
(ii) the second physico-chemical property is ion mobility or mass-to-charge ratio.

13. The mass spectrometry system of claim 8, wherein one or both of the first device configured to separate ions and the second device configured to separate ions is further configured to fragment ions.

14. The mass spectrometry system of claim 8, wherein one or both of the first device configured to separate ions and the second device configured to separate ions comprises:
a separation region configured to receive the ions, the separation region extending in a first direction; and
an electrode arrangement configured to confine the ions in the separation region, wherein the electrode arrangement is configured to:
apply a time-varying potential in the separation region to cause the ions to move in the first direction; and
apply a potential gradient in the separation region, the potential gradient opposing the time-varying potential, such that the ions are separated at different positions in the first direction according to the mass-to-charge ratios of the ions.

15. The mass spectrometry system of claim 1, wherein the mass spectrometry system is configured to perform the MSⁿ mass spectrometry in a data independent acquisition mode.

16. The mass spectrometry system of claim 1, wherein the mass spectrometry system is configured to perform tandem mass-tagging (TMT) analysis.

17. The mass spectrometry system of claim 1, wherein one or more of:
(i) the first mass analyser is a time-of-flight mass analyser;
(ii) the first mass analyser has a resolving power of at least 1000; or
(iii) the first mass analyser is configured to perform mass analysis at a repetition rate of at least 50 Hz.

18. The mass spectrometry system of claim 1, further comprising a second mass analyser.

19. The mass spectrometry system of claim 18, wherein the first mass analyser is configured to perform mass analysis at a higher repetition rate than the second mass analyser.

20. The mass spectrometry system of claim 18, wherein one or both of:
(i) the second mass analyser is configured to perform MS¹ and/or MS² mass analysis; and
(ii) the first mass analyser is configured to perform MSⁿ mass analysis.

21. A method of performing MSⁿ mass spectrometry, where n is greater than or equal to 3, the method comprising:
providing a sample of ions to a mass spectrometry system, wherein the mass spectrometry system comprises:
a first mass filter having a first maximum resolution;
a first fragmentation device downstream of the first mass filter and configured to fragment ions received from the first mass filter;
a second mass filter downstream of the first fragmentation device, the second mass filter having a second maximum resolution that is lower than the first maximum resolution;
a second fragmentation device downstream of the second mass filter; and
a first mass analyser downstream of the second fragmentation device;
performing a first mass filtering on the ions using the first mass filter to provide first mass filtered ions;
performing a first fragmentation on the first mass filtered ions using the first fragmentation device to generate first fragment ions;
performing a second mass filtering on the first fragment ions using the second mass filter to provide second mass filtered ions;
performing a second fragmentation on the second mass filtered ions using the second fragmentation device to provide second fragmented ions; and
performing MSⁿ mass analysis on the second fragmented ions using the first mass analyser.
